(19) United States
(12) Patent Application Publication
(10) Pub. No.: US 2005/0027670 A1
(43) Pub. Date: Feb. 3, 2005

(54) Ranking search results using conversion data

(76) Inventor: Jack G. Petropoulos, Hopkinton, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/631,390

(22) Filed: Jul. 30, 2003

(51) Int. Cl. G06F 7/00

(52) U.S. Cl. 707/1

(57) ABSTRACT

Ranking search results using conversion data is described. According to one embodiment, conversion data is provided to a document; the document being one of a plurality of documents to be searched on a network. The documents are ordered in a search result based on the conversion data.

### TECHNICAL FIELD

Embodiments of the invention relate to the field of computing and, more specifically, to the ranking of search results using conversion data.

### BACKGROUND

A search engine tool is a software program designed to help a user access documents (e.g., web pages) stored on a computer, for example on a network (e.g., local area network, Internet, etc.), by allowing the user to ask for documents meeting certain search criteria (typically those containing a given keyword, a set of keywords, or a phrase) and retrieving documents that are associated with those criteria.

Web search engines work by storing information about a large number of web documents that are retrieved from the Internet. These documents are retrieved by an automated software program (e.g., typically known as a web crawler or spider) which follows and retrieves every associative link well known to those of ordinary skill in the art. The contents of each document is then analyzed to determine how it should be indexed (for example, words are extracted from the titles, headings, or special fields called metatags). This data about the web documents is stored in some form of an index database for use in later queries. Some search engines store all or part of the source page (referred to as a cache) in addition to the information about the web pages.

When a user comes to the search engine and makes a query, the search engine looks up the index and provides a listing (e.g., a search result) of best-matching web documents according to the search criteria, usually with a short summary having at least the document's title and sometimes parts of the text.

The usefulness of a search engine to most people is based on the relevance of search results it gives back. While there may be millions of web documents that include a particular keyword or phrase, often particular documents are more relevant, popular, or authoritative. Most search engines employ methods to rank the results to re-order the search results to provide the “best” search results first. These algorithms (i.e., ranking methods) use various rules applied to keywords to order the results. Examples of such ranking methods include text matching, link analysis, and click popularity, among other well-known methods. How a search engine decides which documents are the best matches, and what order the results should be shown in, varies widely from one engine to another.

### BRIEF SUMMARY OF THE INVENTION

Ranking search results using conversion data is described. According to one embodiment, conversion data is provided to a document, the document being one of a plurality of documents to be searched on a network. The documents are ordered in a search result based on the conversion data.

### BRIEF DESCRIPTION OF THE DRAWINGS

The invention may best be understood by referring to the following description and accompanying drawings that are used to illustrate embodiments of the invention. In the drawings:

FIG. 1 illustrates a network environment according to one embodiment of the invention;

FIG. 2 illustrates one embodiment of a process flow to collect conversion data;

FIG. 3 illustrates one embodiment of a process flow to use the conversion data;

FIG. 4 illustrates an exemplary process of ranking results using conversion data according to one embodiment; and

FIG. 5 illustrates an exemplary computer system suitable for one embodiment of the invention.

### DETAILED DESCRIPTION

In the following description, numerous specific details are set forth. However, it is understood that embodiments of the invention may be practiced without these specific details. In other instances, well-known circuits, structures, and techniques have not been shown in detail in order not to obscure the understanding of this description.

Ranking search results using conversion data is described. According to one embodiment, conversion data is used as a factor in ranking search results from an index-based search engine. Conversion data may include feedback on the behavior of a user following a selection of a document in a search result. Behavior of interest may include the user's progression from an initial selected document to subsequent linked documents that deliver the user to a final conversion activity. Conversion activity may include placing information within a web form, submitting information within a web form, performing an online purchase, downloading digital content for a server, etc.

It should be appreciated that the presentation of a search result represents an attempt to understand a user's need and to meet that need with a presentation of relevant data. The user's reaction to that presentation is indicative of the success of the presentation in meeting the user's need. When a user reacts to the presentation by acting in response to the presentation in a manner called for by the materials presented (such as downloading a product), it is inferred by this behavior that the user is indicating satisfaction with the information presented. When that behavior culminates with a conversion activity, the implication is that the user is highly satisfied. As will be described, a tracking tool may be used to collect and feed the conversion data into a search engine tool for consideration in ranking and ordering the search results in the future.

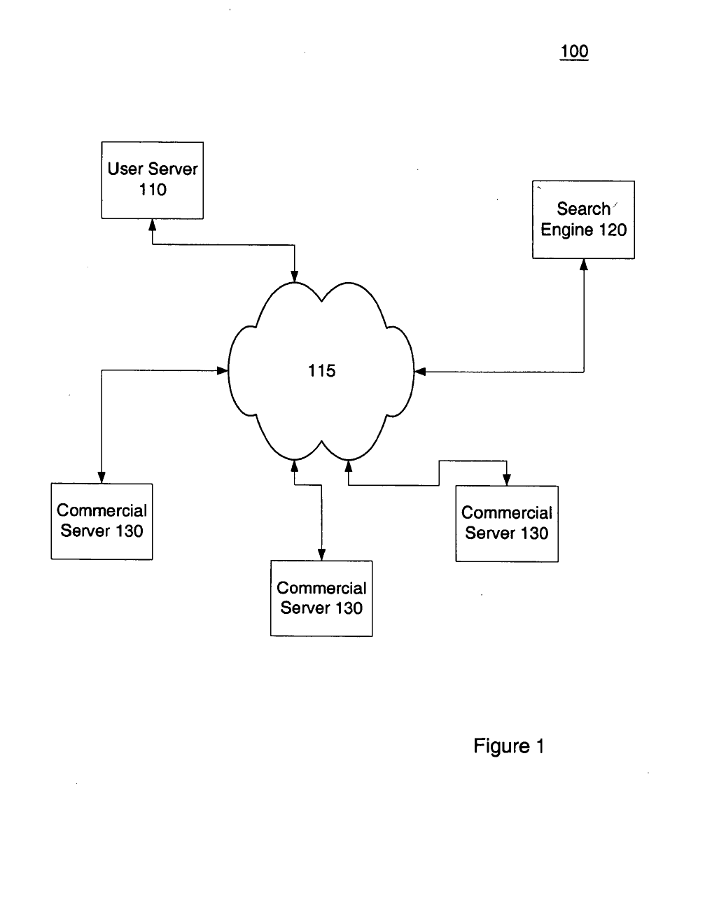

FIG. 1 illustrates a network environment 100 according to one embodiment of the invention. The network environment 100 includes an end-user server 110, a search engine server 120, a commercial server 130, and a network 115.

Each server (110, 120, 130) may be part of, or coupled to the network 115, such as the Internet, to exchange data. Typically, a computer couples to the Internet through an ISP (Internet Service Provider) (not shown) and executes a conventional Internet browsing application to exchange data with an ISP server. Other types of applications allow clients to exchange data through the network 115 without using an ISP. It is readily apparent that the present invention is not limited to use with the Internet; alternatively, directly coupled and private networks are also contemplated.

The search engine server 120 may include a search engine tool, provided by a search provider, to allow a user to search for a document stored on one or more commercial servers 130. The commercial server 130 may store one or more documents that may be of interest to a user. The end-user server 110 may include a means by which a user may connect to the search engine server 120 and/or commercial server 130.

In one embodiment, a service provider of the commercial server 130 may pay the search provider of the search engine 120 each time a user connects to the commercial server 130 via the search engine 120. It should be understood that the user might be more likely to select the first ranked document based on conversion data associated with a query. Therefore, by ordering the search results based on the conversion activity the more relevant documents are ordered first, which benefits the user by providing a relevant sought document, benefits the commercial server by receiving traffic which is more likely to result in conversion activity and potential increased revenue, and benefits the search engine provider by increasing the probability of improved return on investment for its users, and hence more revenue.

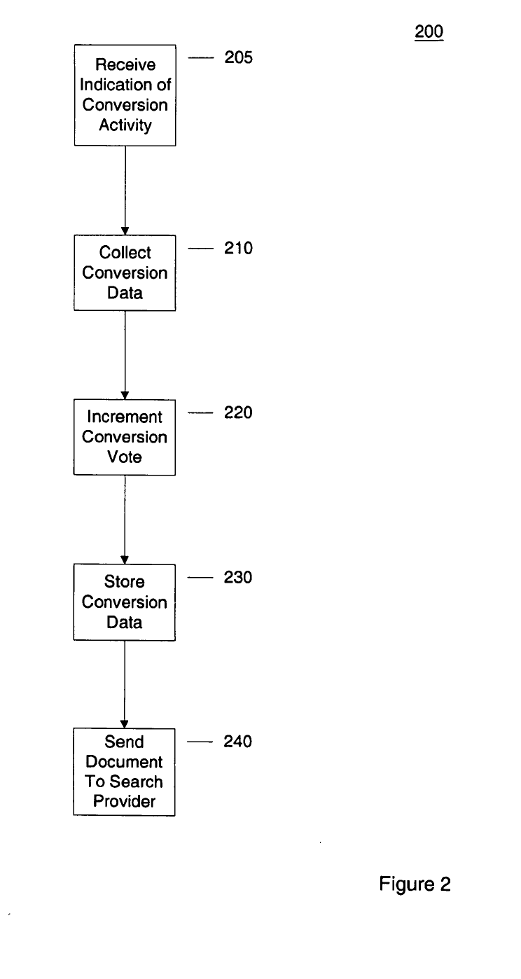

FIG. 2 illustrates one embodiment of a process flow (200) to collect conversion data. At block 205, the commercial server 130 receives an indication of a conversion activity. For example, upon performing a search for jazz music, a user may select “www.jazzmusic.org” to access the commercial server 130 and further download a music file from the commercial server 130.

In one embodiment, conversion data will generally take the form of associating the initial query (e.g., searching for jazz music), with the user's response to a set of options (e.g., selecting wwwjazzmusic.org) when that response is followed by a conversion activity (e.g., downloading a digital music file). It should be understood that this association may be recorded in a variety of ways by a variety of entities and the invention is not limited to those described herein.

At block 210, the commercial server 130 collects conversion data describing the conversion. Conversion data collected may include the type of conversion, when the conversion occurred, who performed the conversion, a number of times that a keyword has been associated with a conversion for a document in which it is contained, a number of other documents for which a keyword has converted, a date of the last time the keyword converted for a document, a number of distinct users converting for the keyword, and revenue associated with the conversion, among other examples.

In one embodiment, the commercial server 130 may collect conversion data through tools that track network traffic. For example, the commercial server 130 may identify a query and may assign an identifier to the user that submitted the query, such as when a user arrives through a search engine. This identifier may be a “cookie” that is placed on the user's computer 110; or, alternatively, it may be an identifier that accompanies the user throughout the conversion activity but does not stay with the user after the visit is concluded, among other methods of tracking user activity well known to those of ordinary skill in the art. For example, in the case where cookies are used, the commercial site 130 may be able to track return visits by the user and may make assumptions about the connection between the first visit, subsequent visits, and conversion activity. The use of cookies to identify and track activities of a user is well known to those of ordinary skill in the art and therefore a further description is omitted so as to not obscure this description.

It should also be understood that in some cases store foot traffic or other metrics, such as telephone inquiries, might be tied to an initial site visit where the connection can be made or inferred. For example, store traffic may be measured by offering a coupon for downloading and redemption at a store. Raw measurements of foot traffic could be used and correlated with web-based campaigns when a downloaded coupon associated with a web page is used for an in-store purchase. In addition, a web page (e.g., document) may provide a specific phone number from which telephone traffic may be measured associated with the web page.

At block 220, the commercial server 130 increments a conversions vote. The conversions vote is a count of the number of times a conversion associated with the document (or a query) has been performed. The conversion votes may be used to rank and order a search result, as will be further described below.

At block 230, the commercial server 130 stores the conversion data within a document associated with the conversion. This allows a document owner to insert conversion data into their documents to affect the ranking of an associated document in response to a future query.

There are certainly many ways that conversion data can be added to the document. In one embodiment, the document may contain specific elements, such as a converting keyword tag that is used to focus the attention of a ranking mechanism such as a search engine's algorithm, on the specific element for purposes of contributing to the presentation of that document in response to a query.

For example, a document may include the following conversion data:

<CONVERTKEYWORD1>Buy Harmonica, <Value 1> 2/9 </Value 1>,
<Value 2> 1/7 </Value 2>, <Value 3> 2/30 <Value 3>),
<Value 4> 5 </Value 4>), <Value 5> $20.18 </Value
5>)</CONVERTKEYWORD 1> <CONVERTKEYWORD 2> Bass
Mouth Harp<Value 1> 3/40 </Value 1>, <Value 2> 2/7 </Value 2>,
<Value 3> 2/30 <Value 3>), <Value 4> 12 </Value 4>),
<Value 5> $25.18 </Value 5>)</</CONVERTKEYWORD 2>

A description of the conversion data is as follows:

<KEYWORD #> distinguishes a unique keyword and defines the set of conversion data that follows as belonging to that keyword.

<Value 1> defines the (total number of conversions/total number of times the document was selected from search results in association with the keyword).

<Value 2> defines the (number of conversions/the most recent 7 day period).

<Value 3> defines the (number of conversions/the most recent 30 day period).

<Value 4> defines the average rank of the document for the keyword.

<Value 5> defines the revenue associated with the conversion.

It should be understood that other keywords and values may be considered and the invention is not limited to those described in this description. For example, alternative values may define an identification of the search engine that generated the conversion, a specific date history of conversions (e.g., day of the week), an identification of specific rank rather than average, an identification of geographic region from which the query was initiated, an identification of special promotional data offered by the site owner, an identification of user behavior, such as the number of previous visits to the site before converting, and visits to other sites before converting, etc.

In another embodiment, a new element is added to the document. For example, a <CONVERSION DATA> tag may be added as a new element. The <CONVERSION DATA> element may be used by the modifier of the document as the place into which only converting keywords or phrases and other relevant conversion data is stored. For example, the following may be metadata language of a typical document modified to include the <CONVERSION DATA> tag as follows:
<URL path=“http://www.musiciansfriendinstruments.com/1635-5841238-5/”>
<SUBSCRIBED>2003/03/14</SUBSCRIBED>
<EXPIRES>2003/04/14</EXPIRES>
<DEST-URL>http://www.musiciansfriend.com/srs7/src=00634/g=bass/search/c=4443</DEST-URL>
<DISPLAY-URL>http://www.musiciansfriend.com/srs7/src=00634/g=bass/search/c=4443</DISPLAY-URL>
<TITLE>Musiciansfriend.com—Bass Harmonicas</TITLE>
<DESC>Musician's Friend is the world's largest direct mail musical equipment company. They have Bass Harmonicas along with all top-names in guitar, bass, drums, keyboard, amplifiers, signal processors, recording equipment, and a wide range of essential gear for</DESC>
<KEYWORDS>Bass Harmonicas; BassHarmonicas</KEYWORDS>
<CONVERTING DATA><KEYWORD 1>Buy Harmonica, <Value 1>2/9</Value 1>, <Value 2>1/7</Value 2>, <Value 3>2/30<Value 3>), <Value 4>5</Value 4>), <Value 5>$20.18</Value 5>)</KEYWORD 1><KEYWORD 2>Bass Mouth Harp<Value 1>3/40 </Value 1>, <Value 2>2/7</Value 2>, <Value 3>2/30<Value 3>), <Value 4>12</Value 4>), <Value 5>$25.18</Value 5>)</</KEYWORD 2></CONVERTING DATA>
<BODY>Bass Harmonicas; When you need fast, accurate, and reliable Bass Harmonicas information or prices, don't hesitate to contact us. We are your specialists in the field and can meet all your needs. You won't find a better source for getting you the best prices on new and used Bass Harmonicas. </BODY>
<LANGUAGE>English</LANGUAGE>
<ADULT>0</ADULT>
<CPC>0.15</CPC>
</URL>

Alternative embodiments of modifying the document with converting keywords or phrases would include, but not be limited to, the separation of converting keyword from unproven keywords within the keyword tag by insertion of white space or a special symbol used to distinguish the converting from the unproven keywords or phrases. An uproven converting keyword is any keyword that does not have a history of converting. For instance at the beginning of a campaign there may be no history of conversions for any of the documents and therefore all keywords would be unproven. Over time certain documents are converted against certain keywords, and therefore will collect conversation data.

Upon modifying the document, process flow 200 continues at block 240 where the commercial server 130 sends the document to a search provider. The search provider may then use the conversion data stored in the modified document to rank and order future results, as will be further described below. In another embodiment, the search engine server 120 may capture the document periodically during retrieval of documents from the web (e.g., via a web crawler or spider). Alternatively, search engine server 120 may track conversion data by attaching tracking tools to the traffic that they generate. These tools return information about user activity in a manner similar to the process that is described above. The search engine 120 may also receive conversion data from the commercial server 130 through the provision of log files, cookies, redirects, or other means of collecting user activity from a subsequently linked site. For example, in one embodiment, the inclusion of code in an URL would cause a cookie to be placed on the user server 110. The cookie would track conversion activity.

For example, it should be understood that service providers, such as Search Engine Marketing (“SEM”) firms, might be retained by an owner of a commercial server 130 to bring user traffic to their site and to track the traffic that is specific to the actions of the SEM. The user traffic may be tracked by assuring that SEM generated traffic is directed by the search engine server 120 to go through “redirect servers” that are generally owned and operated by the SEM. These redirect servers may log the traffic; recording the query, URL (uniform resource locator), and other data, and then send the traffic on to the end-user server 110 via network 115. The SEM may rely on the customer to provide conversion feedback or they may attach identifiers, such as cookies, that are able to track user activity and to report back to the SEM reporting tools. The SEM uses software to extract the conversion data from their redirect servers, to process that conversion data to rank, and order a search result.

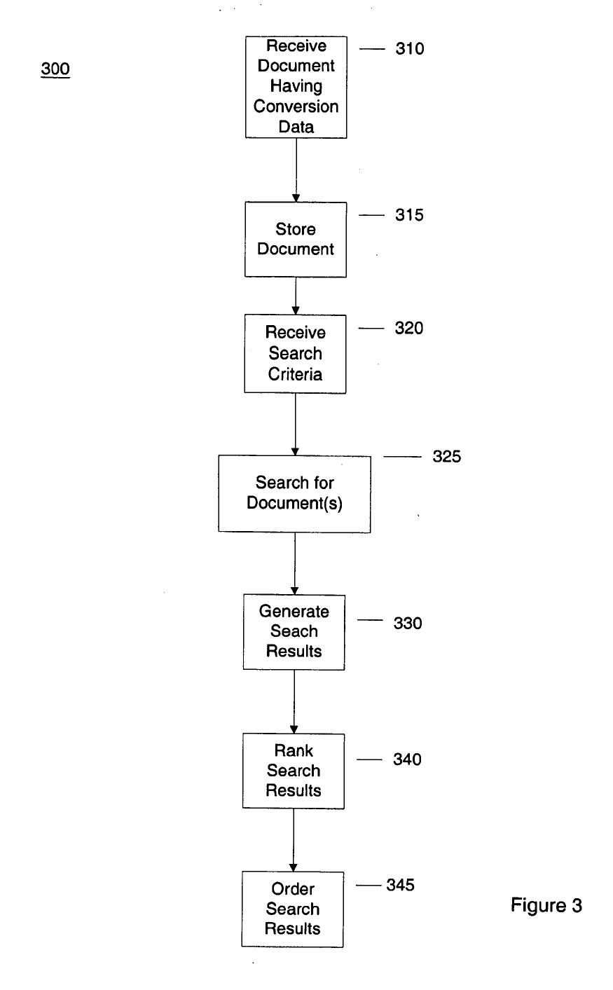

FIG. 3 illustrates one embodiment of a process flow 300 to use the conversion data. At block 310, the search engine server 120 receives a document having conversion data. For example, the search engine server 120 may receive the document from the commercial server 120 as described above.

At block 315, the search engine server 120 stores the document within a searchable index, such as a database. Additional processing may be applied to the stored document to accomplish a variety of tasks intended to standardize the conversion data within the document and to prepare the conversion data for use by an on-line process (e.g., providing a search result based on a query).

For example, in order to make use of the conversion data, the search engine server 120 may define one or more specific rules associated with the conversion data (versus rules that are applied to similar or distinct data that are not qualified as being associated with conversions). The rules may allow the search engine server 120 to attend to, or to ignore, conversion data depending on whether or not the search engine trusts the source of the data. Also, a specific rule may be defined to specify that the conversion data must be presented to the search engine server 120 in a format that is recognizable to the search engine server 120 so that the algorithms may be accurately applied.

The format in which conversion data is presented may be in multiple forms well known to those of ordinary skill in the art. In one embodiment, a specification could be written that would prescribe the format into which conversion data would be transformed by a search provider, and presented to the search engine server 120. If the invention is shared among a variety of search engines, the format of the collected data may be amended to reflect the needs of a particular search engine. Accordingly, the format may specify variables, which may be configured to meet the needs of the particular search engine that is receiving and processing the data.

The rules used to process the data would be changeable over time. They may consider numerous and changing factors, such as the source of the data, type of conversion (e.g., content download, purchase, online registration, foot traffic, phone call, etc.), revenue associated with the conversion, frequency of conversions, etc.

In one embodiment, the documents are stored in independent indexes or combined with existing (non-converting) documents and include the conversion data in addition to relevant content and processed data, such as text, link popularity, and word scores. The search engine server 120 may produce a document for which a number of keywords are specified as being appropriate. In this model, one or more converting keywords (along with related conversion data) may be specified for the particular document.

In one embodiment, the document may be stored in a Query-URL pairs, well known to those of ordinary skill in the art. The Query-URL pair includes computed values and other information in a format that is suitable for use by the search engine server 120 in presenting search results. These computed values would include past or predicted performance calculations including, but not limited to, conversion information.

Having stored the document in the database, the document is now available to be searched by a user. In this way, a document having conversion data may be stored in an index to be analyzed by a search engine tool in response to a query, in an effort to resolve the query according to the goals and objectives of the search engine.

At block 320, the search engine server 120 receives a search criteria. For example, the search engine site may receive search criteria from a user seeking a document on the Internet.

At block 325, the search engine server 120 searches for the documents within the searchable index based on the search criteria.

For example, the search engine server 120 may execute a rule that compares all of the documents in a set of indexes that appear to have some relevance to the user's query. Typically this is an iterative process that begins by looking for documents that include some text that is in common with the user's query.

At block 330, the search engine server 120 generates a search result list of documents associated with the search criteria. In one embodiment, the search engine server 120 executes rules that retrieve document URL pairs in which the recorded query most closely matches the current query. The relative scores of each of the retrieved Query-URL pairs are compared and are used to determine which documents are incorporated into the result set and to set the order in which they appear.

At block 340, the search engine server 120 ranks the search results using, among other factors, the conversion data stored in each selected document. In this way, additional criteria are used to determine which documents will be selected as the most relevant to the user's query, and in which order they are to be presented. These criteria include, but are not limited to, text scores such as word density and hyperlink scores such as link popularity.

For example, the search engine server 120 may rank the search results based on the conversion score (e.g., number of conversion votes) associated with each document. Alternatively, the conversion score may be based a computation of scores used for ranking based on the conversion data. Such score data recorded may include, but is not limited to: a conversion vote (e.g., a number of times that the keyword has been associated with a conversion for the document in which it is contained), a number of other documents for which the keyword has converted, a date of the last time the keyword converted for the document, and a number of distinct users converting for the keyword.

In one embodiment, the final ranking of the search result documents could include consideration of conversion data including, but not limited to, scores derived from the processing of a number of times that the query has been associated with a conversion for the document in which it is contained, a number of other documents for which the keyword has converted, a date of the last time the keyword converted for the document, and a number of distinct individuals converting for the keyword.

At block 345, the search engine server 120 orders and presents to the user the search result based on the ranking of the selected documents.

It should be appreciated that the search results are designed to accomplish the end goal of the search engine. These goals may include, but are not limited to: relevance, revenue, and diversity of results. The process flows (200, 300) may also be configured to change the outcome based on varying considerations. For example, if the query is determined to be focused on educational research, the process may be configured to promote non-commercial material. If the intent of the query is determined to be the purchase of goods or services, the process may be reconfigured to emphasize commercial or converting material. This environment may be accomplished through the use of rules that persist over time and do not consider variables such as the intent of the query, or they may be dynamic so that the process flow is modified on a query-by-query basis.

The search result may also be presented in a format that is useful to the recipient. It should be appreciated that the recipient may be a website that offers search results to its users or it may be an end user who is seeking information directly from the search engine. It may also include commercial entities seeking to execute research using the search engine's database, accepting a direct feed from the engine and using algorithms configured to their particular needs.

The search result may be formatted in extensible markup language (“XML”). Other output formats are considered to be in the scope of this invention. Each result may contain a title, description, and the means to locate the full version of the document that is determined to be relevant to the query. Often the location information will be a URL, but may also be an address, numeric value, a grammatical statement, or any form of information judged to be of value. The output may also present a full version of the information determined to be relevant. This output may be ordered in a manner that is predetermined by the search engine in order to meet its goals of relevance, revenue, etc. The result set may contain information such as scores, revenue, etc. that would allow for reordering of the presented results based on the needs of the end user of the output.

It should be understood that conversion data may be transmitted and recorded in formats other than modified documents. The data may be sent to a database for processing and storage. The database may be used to facilitate various methods of allowing conversion data to affect search results including, but not limited to, Query-URL pairs.

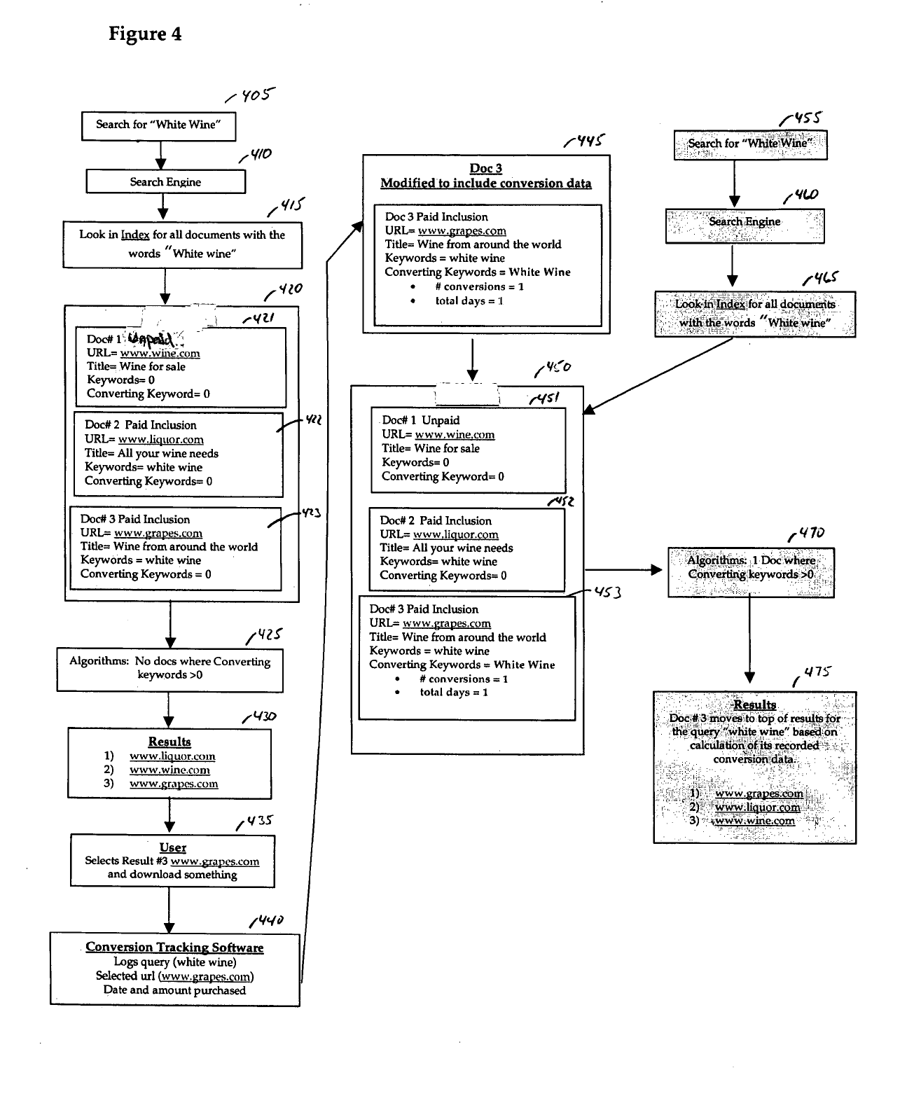

FIG. 4 illustrates an exemplary process of ranking results using conversion data, according to one embodiment.

At block 405, a user performs a search for “White Wine.” The search engine receives the query (410). The search engine searches an index for all documents with the words “White Wine” (415). The search engine selects a result search (420) of related documents (421, 422, 423). Each document (421, 422, 423) indicates a value of zero for a converting keyword (e.g., a conversion vote of zero). The search engine determines that no documents should be ranked based on the converting keyword because conversion data does not exist in the documents (425). The search engine orders the documents according to algorithms that, in this case, do not have a conversion history factor to consider, and presents the search results to the user (430)., The user selects the third document in the presented results and downloads a file, such as the user may download information about excellent white wine makers (i.e., performs a conversion activity) on a commercial server (435).

Conversion tracking software captures conversion data associated with the conversion activity, such as the query (“white wine”), the selected document (“www.grapes.com” XML document), the date of the download, and what was downloaded (440). The document selected by the user is modified to include the captured conversion data including the number of conversions and the total days (445). The total days may be the number of days that the document has been in the index. In this case the total days=1 and # conversions=1 so this document has a 1:1 days conversions ratio. It is understood that the invention is not limited to the examples described herein of how conversion data can be turned into useful data for measuring relevance. In alternative embodiments other formulas or data calculations may be used that are well known to those of ordinary skill in the art, which are not described here so to not obscure this description. A copy of the modified document is placed with the updated search index of the search engine (450).

At block 455, a subsequent user makes a subsequent query for “white wine.” This subsequent query may be performed the next day. The search engine receives the query (460) and searches the search index for all documents with the words “white wine” (465). The search engine selects a result search (450) of related documents (451, 452, 453). The search engine determines that the third document (453) includes conversion data where the converting keywords are greater than zero. The search engine orders the third document as the first document listed based on an overall calculation of values which includes its recorded conversion data (475).

In an alternative embodiment, rather than modifying documents to include conversion data, a database may be maintained to record the relationship between a query and a document when there is a demonstrated history of a converting relationship between the two.

Converting queries (keywords), and the URLs (documents) for which they converted, may be submitted by various sources, including site owners, service providers, or other interested parties. The recipient of the data would aggregate converting Query-URL pairs into a database that would be used to store and process those records for use in responding to future queries that match historical queries in the database. The recipient would typically be a search engine that would have rules for accepting, processing, and using the data. The recipient could also be a third party that would distribute the data in either its raw form or, after processing the data, according to the rules of the downstream partner(s) to whom the data is provided.

In yet another alternative embodiment, output of an aggregated database of conversion data is the generation of database-generated document elements. This method of document creation envisions the use of conversion data to generate additional elements that could be inserted into existing documents. In this scenario, documents in the search engine's index would be dynamically modified as conversion data is generated when that data is determined to have relevance to the particular document.

It is also possible that new documents could be generated based on the passed conversion data. In this scenario, an existing document could appear in a result set and be selected by a user. If the user takes action that generates conversion data, relevant information is passed back to the search engine server 120 and stored in the database. The database rules will govern the points at which this information is sufficient to cause the database to generate a new document. The new document will be constructed in a manner that reflects the positive portions of the original document and is modified by data that is specific to the conversion. In this manner, a new and optimized document is created specific to the converting query. For example, a user searches for “jazz music” and selects a result and downloads specific jazz music. However, the related document may not use the term “jazz music” for the title of the search result. If it is believed that the conversion implies that this term is important, a document is constructed (or modified) that contains this known converting keyword in the title. Having the term in the title will likely help this document to rank in the future and will make the document more relevant to users who are looking for jazz music.

It will be appreciated that more or fewer processes may be incorporated into the methods illustrated in FIGS. 2, 3, and 4 without departing from the scope of the invention, and that no particular order is implied by the arrangement of blocks shown and described herein. It should be appreciated that, by describing the methods by reference to a process flow diagram, one skilled in the art is enabled to develop such programs including instructions to carry out the methods on suitably configured machines (the processor of the machine executing the instructions from machine-readable media, including memory). The machine-executable instructions may be written in a computer programming language or may be embodied in firmware logic. If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic, etc.), as taking an action or causing a result. Such expressions are merely a shorthand way of saying that execution of the software by a computer causes the processor of the computer to perform an action or produce a result.

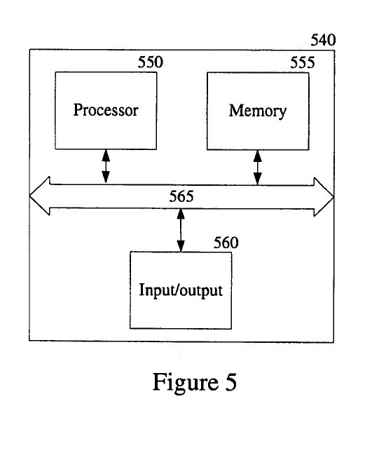

One embodiment of a computer system suitable for use in the network environment 100 of FIG. 1 is illustrated in FIG. 5. The system 540 includes a processor 550, a memory 555 and an input/output capability 560 coupled to a system bus 565. The memory 555 is configured to store instructions which, when executed by the processor 550, perform the methods described herein. The memory 555 may also store documents having conversion data. Input/output 560 provides for the delivery and display of the documents having conversion data or portions or representations thereof. Input/output 560 also encompasses various types of machine or computer-readable media, including any type of storage device that is accessible by the processor 550. One of skill in the art will immediately recognize that the term “computer-readable medium/media” or “machine-readable medium/media” further encompasses a carrier wave that encodes a data signal. It will also be appreciated that the computer is controlled by operating system software executing in memory 555. Input/output and related media 560 stores the machine/computer-executable instructions for the operating system and methods of the present invention as well as the documents having conversion data.

The description of FIG. 5 is intended to provide an overview of computer hardware and various operating environments suitable for implementing the invention, but is not intended to limit the applicable environments. It will be appreciated that the system 540 is one example of many possible devices that have different architectures. A typical device will usually include at least a processor, memory, and a bus coupling the memory to the processor. Such a configuration encompasses personal computer systems, network computers, television-based systems, such as Web TVs or set-top boxes, handheld devices, such as cell phones and personal digital assistants, and similar devices. One of skill in the art will immediately appreciate that the invention can be practiced with other system configurations, including multiprocessor systems, minicomputers, mainframe computers, and the like. The invention can also be practiced in distributed computing environments where tasks are performed by remote processing devices that are linked through a communications network.

Ranking search results using conversion data has been described. Although specific embodiments have been illustrated and described herein, it will be appreciated by those of ordinary skill in the art that any arrangement, which is calculated to achieve the same purpose, may be substituted for the specific embodiments shown. This application is intended to cover any adaptations or variations of the present invention.

While the invention is not limited to any particular implementation, for the sake of clarity a simplified method and apparatus to rank and order search results using conversion data has been described. For example, those of ordinary skill within the art will appreciate that the document need not be generated on a commercial server, but can be generated from any type of server on a network.

While the invention has been described in terms of several embodiments, those skilled in the art will recognize that the invention is not limited to the embodiments described. The method and apparatus of the invention can be practiced with modification and alteration within the scope of the appended claims. The description is thus to be regarded as illustrative instead of limiting on the invention.

1. A method ordering documents comprising:
providing conversion data to a document, the document being one of a plurality of documents to be searched; and
ordering the document in a search result based on the conversion data.

2. The method of claim 1, wherein ordering the document further comprises:
ranking the document based on the conversion data.

3. The method of claim 1, wherein the conversion data indicates a previous user submitted a form upon selecting the document.

4. The method of claim 1, wherein the conversion data indicates a previous user downloaded digital content upon selecting the document.

5. The method of claim 1, wherein the conversion data indicates a previous user purchased an item upon selecting the document.

6. The method of claim 1, wherein providing conversion data further comprises:
providing a conversion data tag with the document.

7. A method of providing conversion data comprising:
receiving an indication of a conversion activity associated with a document; and
providing conversion data to the document based on the conversion activity.

8. The method of claim 7, wherein the conversion activity includes submitting a form.

9. The method of claim 7, wherein the conversion activity includes downloading content.

10. The method of claim 7, wherein the conversion activity includes purchasing an item.

11. The method of claim 7, further comprising:
sending the document to a search provider.

12. The method of claim 7, further comprising:
storing the document in a database, the database having a plurality of documents.

13. The method of claim 7, further comprising:
retrieving a search criteria; and
generating a search result of documents, including the stored document.

14. The method of claim 13, further comprising:
ordering the document in the search result based on the conversion data.

15. A method of ordering documents comprising:
associating a conversion activity to a document; and
ordering the document in a search result based on the conversion activity.

16. The method of claim 15, wherein the search result includes a plurality of documents.

17. The method of claim 15, wherein the conversion activity includes a submission of a web form associated with the document.

18. The method of claim 15, wherein the conversion activity includes a download of content associated with the document.

19. The method of claim 15, wherein the conversion activity includes a purchase associated with the document.

20. An apparatus comprising:
a document capable of storing conversion data; and
a search engine tool to order a search result having the document, the ordering of the search result to be based on the conversion data.

21. The apparatus of claim 20 further comprising:
a tracking tool to capture conversion activity associated with the document and to modify the document to include the conversion data associated with the conversion activity.

22. The apparatus of claim 20, wherein the document stores the conversion data as a metadata.

23. The apparatus of claim 20, wherein the search engine tool orders the search result by ranking the conversion data associated with the document.

24. An apparatus comprising:
means for associating a conversion activity to a document; and
means for ordering the document in a search result based on the conversion activity.

25. The apparatus of claim 24, wherein the search result includes a plurality of documents.

26. The apparatus of claim 24, wherein the conversion activity includes a submission of a web form associated with the document.

27. The apparatus of claim 24, wherein the conversion activity includes a download of content associated with the document.

28. The apparatus of claim 24, wherein the conversion activity includes a purchase associated with the document.
